(19) United States
(12) Patent Application Publication
(10) Pub. No.: US 2003/0034600 A1
(43) Pub. Date: Feb. 20, 2003

(54) Telescopic leg bearing

(76) Inventor: Franz Josef Wolf, Bad Soden-Salmuenster (DE)

Correspondence Address: SCHIFF HARDIN & WAITE, 6600 SEARS TOWER, 233 S WACKER DR, CHICAGO, IL, 60606-6473, US

(21) Appl. No.: 10/211,662

(22) Filed: Aug. 1, 2002

(30) Foreign Application Priority Data
Aug. 2, 2001 (DE) 101 37 762.2-21

(51) Int. Cl. B60G 13/00

(52) U.S. Cl. 267/218

(57) ABSTRACT

A telescopic leg bearing has an inner connector part and an outer connector part arranged on both sides of the inner connector part, which parts are configured for connecting the telescopic leg head and provide for fastening to a chassis of a vehicle. To provide a structure-borne sound insulation between the connector parts, at least two resilient supporting hoses are arranged on both sides of the inner connector part and at least one throttling port is provided that connects the inside volumes of the supporting hoses to one another in a communicating fashion.

### BACKGROUND OF THE INVENTION

The invention is directed to a telescopic leg bearing or a bearing for a strut, such as a shock-absorbing leg of a MacPherson strut unit. The bearing has an inner connector part and an outer connector part arranged at both sides of the inner connector part that are configured for connecting a telescopic leg head and provided for fastening to the chassis of a vehicle, whereby a structure-borne sound insulation is provided between the connector parts.

Telescopic legs usually comprise a steel coil spring as well as a shock absorber, which is arranged in a parallel circuit with the steel coil spring and are configured for the damped cushioning of dynamic loads with high amplitude and low frequency. Structure-borne sound, in contrast, is characterized by a comparatively higher frequency with low amplitude and is transmitted nearly undamped by the steel coil spring and the shock absorber.

For this reason, a telescopic leg bearing, which leads to a reduction of the structure-borne sound that is transmitted, is introduced at the head of the telescopic leg in the standard Prior Art. A structure-borne sound insulation is usually provided between two rigid, annularly fashioned connectors of the telescopic leg bearing. The structure-borne sound insulation, which is likewise annular, is usually composed of one or more solid elastomer springs that are clamped between the bearing connectors. The elastomer rings are thus pre-stressed during operation. One of the bearing connectors is rigidly connected to the chassis and the other is rigidly connected to the shock absorber of the telescopic leg.

In particular, it is known to arranged telescopic leg bearing connectors fashioned disk-shaped in what is referred to as a sandwich structure. One connector is composed of two disks offset relative to one another in axial direction that are concentrically arranged and rigidly connected to one another via a cylindrical connecting web in their central region. The other bearing connector is arranged between these disks and comprises a central through opening freely penetrated by the connecting web in order to enable an axial mobility. In order to be able to effectively damp a relative motion of the central bearing connector and, in particular; structure-borne sound, solid, annular elastomer springs are provided at both sides of the central bearing connector and are clamped between the connectors by means of an expedient screw-type connection.

The clamped elastomer spring is suitably selected in view of its damping properties in order to as effectively as possible damp the passage of the structure-borne sound that, for example, is generated by the undercarriage of a motor vehicle and transmitted via the telescopic leg. Unwanted noises in the chassis and, thus, in the passenger compartment are reduced in this way.

Known telescopic leg bearings have the disadvantage that the elastomer springs exhibit a limited, insufficiently broad bandwidth in view of the entire frequency spectrum of the structure-borne sound to be damped, so that structure-borne sound waves having a frequency that lies outside this bandwidth are not damped or absorbed and can penetrate unimpeded into the passenger compartment. Over and above this, the annular elastomer spring comprises essentially no resilient properties that could promote the spring effect of the telescopic leg and enhance the passenger comfort.

### SUMMARY OF THE INVENTION

It is therefore an object of the invention to offer a telescopic leg bearing of the species initially cited that enables an improved structure-borne sound insulation over broad frequency ranges and, over and above this, further enhances the passenger comfort.

This object is inventively achieved in that the structure-borne sound insulation is composed of at least two pneumatically resilient supporting members or hoses that are arranged at both sides of the inner connector part, and has at least one throttling port which is provided to connect the inside volumes of the supporting hoses or members to one another in communicating fashion.

The inventive telescopic leg bearing exhibits the advantage that the supporting hoses or members filled with air or some other gas act as pneumatic springs and, beyond the mere structure-borne sound insulation, thus resiliently engage in the connection of the telescopic leg to the chassis. The throttling port or each of the throttling ports damps the occurring amplitudes and—over and above this—prevents the passage of structure-borne sound, whereby the damping characteristic is dependent of the dimensioning of the throttling port in a frequency-related fashion. A structure-borne sound insulation that is improved compared to elastomer springs thus arises, since a structure-borne sound insulation over broad frequency ranges is also inventively enabled.

Advantageously, at least one of the supporting hoses or members comprises one or more gas connections that is/are provided for connecting the supporting hoses to a gas pressure control. The gas pressure control makes it possible to set the internal pressure of the supporting hoses in conformity with the respective demands. Since the internal pressure prevailing in the supporting hoses or members determines the rigidity of the supporting members or hoses acting as pneumatic springs, setting, for example, a high internal pressure in the supporting hoses makes it possible to set the telescopic leg bearing with a hard suspension in order to thus enable an optimally direct connection of at least a part of the telescopic leg to the chassis. A lower internal pressure, in contrast, sees to lower rigidity of the supporting hoses and, thus, to a comparatively soft absorption of dynamic loads.

In order to reduce the manufacturing costs of the elastomer, it is advantageous to provide the gas connection in the inner connector part itself, whereby a pressure conduit extends between the throttling port and the gas connection and the throttling port is likewise within the inner connector part. In this way, the elastomer can be manufactured without gas connection and, thus, even more cost-beneficially.

In a preferred exemplary embodiment, the inside volumes of the supporting hoses are only partially limited by an elastically deformable elastomer. The elastomer, which is utilized given this embodiment, is therefore not circumferentially closed but equipped band-like with two free lateral edges. Suitable clamp parts are provided for forming the supporting hoses, and the clamp parts provide a gas-tight connection by the free lateral edges of the elastomer to the connector parts due to their snug fit that occurs when charged with pressure.

Expediently, the inner connector part is a chassis connector part that is provided for securing to the chassis of a motor vehicle, for example by screwing. The outer connector part, in contrast, is configured as a telescopic leg connector part and is provided for connection to at least a part of the telescopic leg.

The telescopic leg can be connected only to the telescopic leg connector part. Given this embodiment of the invention, both the shock absorber of the telescopic leg as well as its steel coil spring are connected to the telescopic leg connector part, whereby the telescopic leg connector part comprises elastomer bumpers provided for supporting the coil spring.

In an embodiment of the invention differing therefrom, the telescopic leg is only partly connected to the telescopic leg bearing, for example only to the head rod of a shock absorber, whereby the coil spring of the telescopic leg is supported at the chassis connector part. In this embodiment, the chassis connector part comprises an additional annular channel in which elastomer bumpers suitably configured for supporting the coil spring are provided.

The telescopic leg connector part expediently comprises two separate sections fashioned circular in cross-section in whose edge region an all-around channel is provided. The two sections of the telescopic leg connector part further comprise a central through opening in which a clamp part that can be plugged together is provided for clamping the two sections. In the assembled condition, the all-around channels in the edge region of the telescopic leg connector part face toward one another and are configured for the respective acceptance of at least one supporting hose. They are thus arranged at different sides of the chassis connector part, which comprises a central recess that is freely penetrated by the sections such that an axial mobility of the telescopic leg connector part relative to the chassis connector part is established. The assembly of the telescopic leg bearing is facilitated as a result of the clampability of the sections, since the separate sections can be introduced to the chassis connector part comprising the supporting hoses from both sides and clamped to one another in the central recess. In a departure from the embodiment described here, the connecting of the sections can also be realized, for example, by engaging connector parts or by screwing the sections.

It is also possible in the scope of the invention that respectively two supporting hoses are provided at each side of the inner connector part, their inside volumes being respectively connected to one another via an additional throttling port.

Further expedient developments and advantages of the invention are the subject matter of the following description of exemplary embodiments of the invention with reference to the Figures of the drawing.

### BRIEF DESCRIPTION OF THE DRAWINGS

FIG. 1 is a schematic, cross-sectional view of the inventive telescopic leg bearing;

FIG. 2 is a schematic, cross-sectional view of another exemplary embodiment of the inventive telescopic leg bearing;

FIG. 3 is a cross-sectional view of a preferred exemplary embodiment of the inventive telescopic leg bearing; and

FIG. 4 is a partial cross-sectional view of a further exemplary embodiment of the inventive telescopic leg bearing.

### DESCRIPTION OF THE PREFERRED EMBODIMENTS

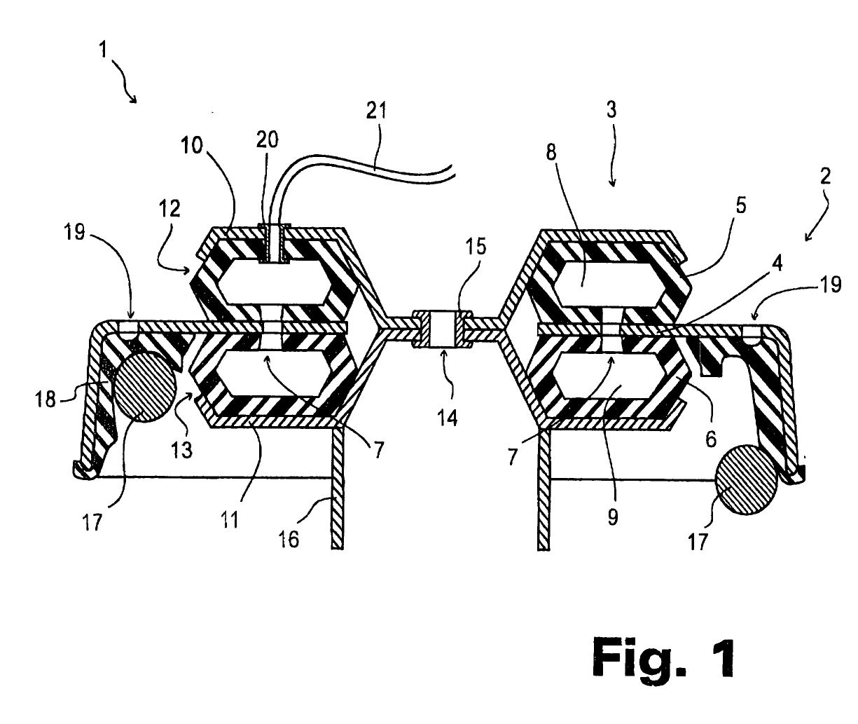

FIG. 1 shows a cross-sectional view of an exemplary embodiment of an inventive telescopic leg bearing I in a schematic illustration. The telescopic leg bearing 1 comprises a circular profile that cannot be recognized given the form of presentation selected and comprises an inner connector part fashioned as chassis connector part 2 as well as an outer connector part fashioned of telescopic leg connector part 3. These parts are usually fabricated of sheet metal.

The chassis connector part 2 is fashioned of one piece and comprises a radially central inner section 4 that is connected at both surfaces to a respective, all-around elastic supporting hose 5, 6. In this exemplary embodiment, the supporting hoses 5, 6 are essentially completely fabricated of an elastic material such as rubber or some other elastomer.

Throttling ports 7, which are opened at both surfaces, are also provided in the inner section 4, and these ports 7 extend through the inner section 4 and the sidewalls of the supporting hoses 5, 6 to connect the inside volumes 8, 9 of the supporting hoses 5, 6 to one another in a communicating fashion. In order to avoid a slipping of the supporting hoses 5, 6 and, thus, a plugging of the throttling ports 7, the supporting hoses 5, 6 are firmly coupled to the inner section 4, whereby the connection can ensue in an arbitrary way, for example by gluing or vulcanizing.

The supporting hoses 5, 6 are respectively supported at an upper section 10 or, respectively, at a lower section 11 of the telescopic leg connector part 3, whereby the sections 10, 11 likewise comprise a circular profile (not visible in this illustration) and also comprise respective, all-around channels 12, 13 in their edge region for the acceptance and stabilization of the supporting hoses 5, 6 in a radial direction.

The telescopic leg connector part 3 is thus arranged at both sides of the chassis connector part 2, which has a central recess that is suitably dimensioned in order to receive the part 3 and to assure the axial mobility of the telescopic leg connector part 3. Thus, the part 3 has an elastic bearing at the chassis connector part 2.

The sections 10, 11 of the telescopic leg connector part 3 comprise a central through opening 14 in which a schematically indicated clamp part 15 is provided for the rigid connection of the sections 10, 11. The connection of the sections 10, 11, however, can be implemented in an arbitrary way, for example by screwing or gluing. The telescopic leg connector part 3 also comprises a cylindrically fashioned tubular connection piece 16 that is provided for the acceptance of the head part of a shock absorber (not shown). The shock absorber is thereby arranged in the connection piece 16 so that it has the free end of a head rod extending up to the clamp part 15, to which the head rod is firmly connected by means of a screw-type connection. To this end, the clamp part 15 comprises, for example, an inside thread that is configured for matching an outside thread of the head rod.

In order to support a steel coil spring 17 at the chassis connector part 2 in a material-preserving way, additional elastomer bumpers or rubber bumpers 18 are provided. These bumpers have an insulating effect for structure-borne sound.

For a firm connection to the chassis of a motor vehicle, the chassis connector part 2 has connection openings 19 that are provided for the acceptance of suitable locking or attachment screws (not shown). In order to enable an optimally easy mounting or assembly of the chassis connector part 2, the rubber bumpers 18 have recesses in the region of the connection openings 19 that simplify the introduction and clamping of the locking or attachment screw.

In addition, a gas connection 20 is provided at the upper section 10 of the telescopic leg connector part 3, and this gas connection 20 passes through the wall of the supporting hose 5 as well as the upper section 10 of the telescopic leg connector part 3. The gas connection 20 is connected to a compressed air conduit 21 that connects the inside volumes 8, 9 of the supporting hoses 5, 6 to a gas pressure or compressed air control (not shown), so that the pressure prevailing in the supporting hoses 5, 6 can be regulated via the compressed air control. The spring rating of the supporting hoses is adjustable via the selected inside pressure in this way and can be adapted to the respective travel conditions. Given, for example, high-speed travel in limited access highways, a hard suspension and, thus, an optimally direct connection of the undercarriage to the chassis is desirable, in contrast whereto an optimally softly resilient absorption of the undercarriage vibration is advantageous given, for example, bumpy roads.

With the assistance of the telescopic leg bearing 1, a force introduced via the shock absorber (not shown) of the telescopic leg is first transmitted onto the telescopic leg connector 3, which thereby moves, for example, upward. In this way, an oppositely directed modification of the inside volumes 8, 9 occurs, whereby the inside volume 9 is compressed in this case but the inside volume 8 is relaxed. Due to the pressure difference that occurs in the chambers 8, 9, gas such as, for example, air flows through the throttling ports 7 (show disproportionately large in FIG. 1), as a result whereof a damping is achieved whose extent and frequency behavior are dependent on the dimensions of the throttling port 7. Due to the elastic properties of the supporting hoses 5, 6, the force introduced via the shock absorber is resiliently absorbed and damped at the same time, whereby—over and above this—a structure-borne sound insulation is offered whose bandwidth is widened compared to solid elastomer springs that are usually employed. Over and above this, the inventive telescopic leg bearing 1 engages resiliently in the transmission of shocks onto the chassis, so that an improved shock insulation of the chassis arises. The spring rating can thereby be regulated via the compressed air control and can be adapted to the respective external conditions.

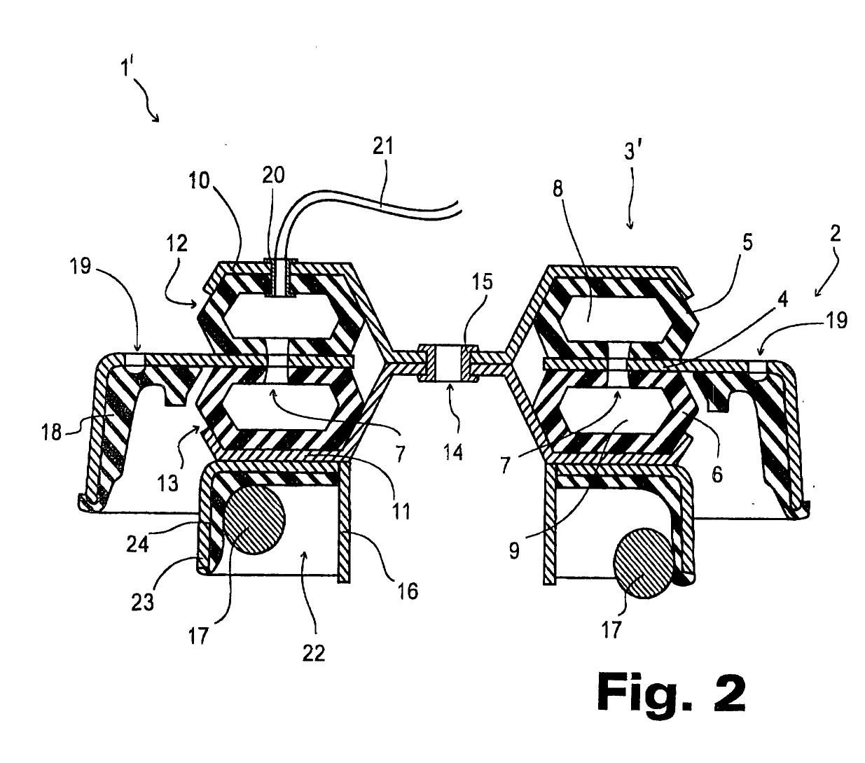

FIG. 2 shows another exemplary embodiment of the telescopic leg bearing 1′ according to FIG. 1 is a schematic illustration. In contrast to the exemplary embodiment shown in FIG. 1, the lower section of the telescopic leg connector 3′ comprises a steel spring channel 22 that radially embraces the connection piece 16 and that is limited by a profiled sheet 23. The steel spring channel 22 is provided for the acceptance of the steel coil spring 17 of the telescopic leg, whereby the profiled sheet 23 is lined with an elastic material 24, for example with an elastomer, against which the head region of the steel coil spring is supported. The elastic material 24 acts as an inside buffer and exhibits a resilient and damping effect—even though a lesser such effect compared to the supporting hoses 5, 6 and also serves the purpose of avoiding squeaking noises that can arise when metallic surfaces rub against one another.

Due to the exclusive linking of the telescopic leg to the telescopic leg connector part 3′, a force introduced by the telescopic leg is introduced exclusively into the telescopic leg connector part 3′ and, thus, is completely absorbed by the supporting hoses 5, 6 in a resilient fashion. An even greater influence of the telescopic leg bearing 1′ on the telescopic leg characteristic is enabled in this way.

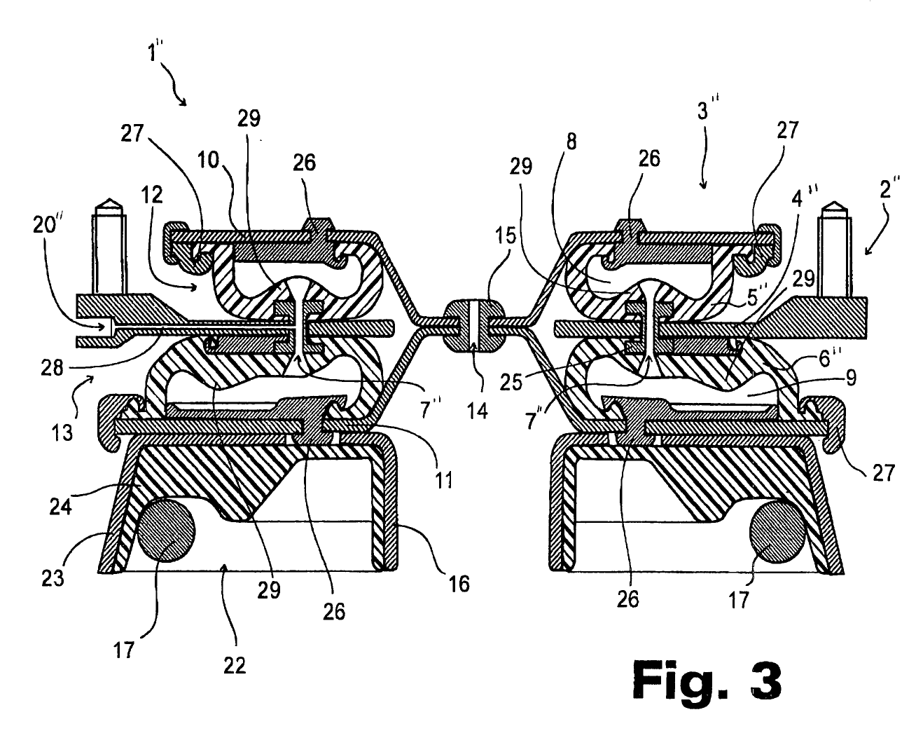

FIG. 3 shows a preferred exemplary embodiment of the inventive telescopic leg bearing 1″ wherein the supporting hoses 5″, 6″—in contrast to those of FIGS. 1 and 2—are only partly limited by an elastomer. The elastomer utilized in this exemplary embodiment is fashioned band-like and comprises lateral edges. When the supporting hoses 5″, 6″ are charged with pressure, a gas-tight snug fit of the elastomer with expediently designed clamp parts occurs, so that the supporting hoses 5″, 6″ are also partially formed by the connector parts 2″, 3″. The manufacturing costs of the elastomer and, thus, of the supporting hoses 5″, 6″ are reduced in this way.

When viewed in greater detail, one can see that an annular, inner clamp part 25 is provided at the connector part 2″ that passes through the inner section 4″ at both sides and comprises a through opening open at both sides for forming the throttling port 7″. The inner clamp part 25 comprises laterally projecting shoulders at both sides, and the elastomer hoses 5″ or 6″ are at least partly clamped between these and the inner section 4″. A slippage of the supporting hoses 5″, 6″ and, thus, a plugging of the throttling port 7″ are avoided by this clamping in the region of the throttling port 7″.

Outer clamp parts 26 or, respectively, edge clamp parts 27 are provided for clamping the elastomer firmly to the telescopic leg connector part 3″. The respective elastomer for forming the supporting hoses 5″, 6″ is clamped gas-tight between these at the two free lateral edges.

In order to additionally lower the manufacturing costs of the elastomer, the gas connection 20″ is arranged at the outer edge of the chassis connector part 2″. The pressure charging of the inside volumes thus ensues via the throttling port 7″, which is connected to the gas connector 20″ via an inner pressure conduit 28 and extends in the chassis connector part 2″.

As was already shown in FIG. 2, both the steel coil spring 17 as well as the telescopic leg head are also connected to the telescopic leg connector part 3″ in the preferred exemplary embodiment according to FIG. 3, and as a result whereof an improved insulation of the passenger compartment is offered compared to the exemplary embodiment shown in FIG. 1.

In order to avoid a knocking of the connector parts 2″, 3″ given a sudden drop in pressure in the supporting hoses 5″, 6″, impact bumpers 29 are provided in the form of thickened portions of the elastomer of the supporting hoses 5″, 6″. As a result of the impact bumpers 29, the respectively opposite connector part 2″ or, respectively, 3″ can be resiliently held even given excursions that exceed a design-prescribed maximum size. In addition, metal parts are prevented from striking against one another even in case of malfunction. The described telescopic leg bearing 1″ thus exhibits what are referred to as emergency running properties.

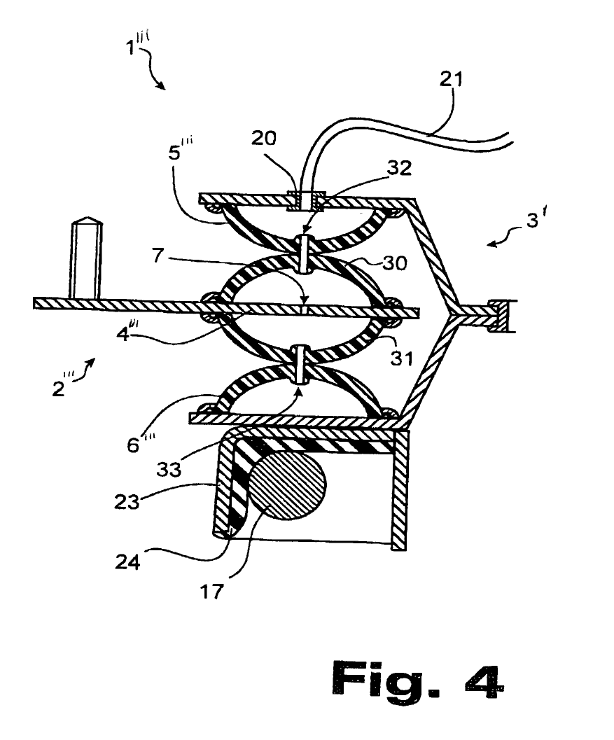

FIG. 4 shows another exemplary embodiment of the essentially rotational-symmetrical telescopic leg bearing 1′″ in a partial illustration. In addition to comprising the supporting hoses 5′″ and 6′″ arranged at both sides of the inner section 4′″ of the chassis connector part 2′″, the telescopic leg bearing 1′″ shown here comprises additional supporting hoses 30 and 31 that are likewise arranged at both sides of the inner section 4′″. An elastomer that is fashioned x-shaped and of one piece in the illustrated sectional view serves both for limitation of the supporting hose 5′″ as well as for limitation of the supporting hose 30, and an additional throttling port 32 connects the inside volumes of the supporting hoses 5′″ and 30 to one another.

The same is true of the supporting hoses 6′″ and 31, whose inside volumes are connected to one another via an additional throttling port 33. The frequency-related damping behavior of the telescopic leg bearing 1 that occurs is thus also dependent on the diameter and length of the additional throttling ports 32 and 33, so that additional manipulated variables are provided in this exemplary embodiment that enable an more precise adaptation of the damping behavior or of the bearing characteristic to the respective conditions of use.

Although various minor modifications may be suggested by those versed in the art, it should be understood that we wish to embody within the scope of the patent granted hereon all such modifications as reasonably and properly come within the scope of our contribution to the art.

I claim:

1. In a telescopic leg bearing having an inner connector part and an outer connector part arranged on both sides of the inner connector part, one of said connector parts being connected to a telescopic leg head and the other of the connector parts being provided for fastening to a chassis of a vehicle, a structure-borne sound insulation being provided between the connector parts, the improvement comprising the structure-borne sound insulation being composed of at least two pneumatically resilient supporting hoses that are arranged on both sides of the inner connector part, and at least one throttling port being provided that connects the inside volumes of the supporting hoses to one another in a communication fashion.

2. In a telescopic leg bearing according to claim 1, which includes at least one gas connector being provided via which the supporting hoses are connectible to a gas pressure control for the controllable setting of the internal pressure of said supporting hoses.

3. In a telescopic leg bearing according to claim 2, wherein the inner connector part is a chassis connector part that is provided for securing the telescopic leg bearing to the chassis and the outer connector part is a telescopic leg connector part that is provided for connecting at least a part of the telescopic leg.

4. In a telescopic leg bearing according to claim 3, wherein the gas connection is arranged within a chassis connector part and is connected to a throttling port via an inner pressure conduit that likewise extends within the chassis connector part.

5. In a telescopic leg bearing according to claim 3, wherein the chassis connector part has elastomer bumpers for support of a coil spring of the telescopic leg.

6. In a telescopic leg bearing according to claim 3, wherein the telescopic leg connector part has elastomer bumpers for support of a coil spring of the telescopic leg.

7. In a telescopic leg bearing according to claim 3, wherein the telescopic leg connector part is composed of two circular sections with edge regions having acceptance channels for supporting the supporting hoses, said two circular sections being connected to one another via a central clamp part.

8. In a telescopic leg bearing according to claim 1, wherein the supporting hoses are only partially formed by an elastomer.

9. In a telescopic leg bearing according to claim 1, wherein two supporting hoses are provided on each side of the inner connector part, the inside volumes of said supporting hoses being connected to one another by respective throttling ports.
